(19) United States
(12) Patent Application Publication
(10) Pub. No.: US 2022/0283909 A1
(43) Pub. Date: Sep. 8, 2022

(54) ORGANIZATIONAL AWARENESS FOR AUTOMATING DATA PROTECTION POLICIES WITH SOCIAL GRAPH INTEGRATION

(71) Applicant: EMC IP Holding Company LLC, Hopkinton, MA (US)

(72) Inventors: Arun Murti, Mission Viejo, CA (US); Mark Malamut, Aliso Viejo, CA (US); Adam Brenner, Mission Viejo, CA (US)

(21) Appl. No.: 17/351,461

(22) Filed: Jun. 18, 2021

Related U.S. Application Data
(63) Continuation-in-part of application No. 17/193,342, filed on Mar. 5, 2021.

(51) Int. Cl. G06F 11/14; H04L 29/12; H04L 29/08

(52) U.S. Cl. CPC G06F 11/1464; G06F 11/1469; G06F 11/1451; G06F 11/1461; H04L 61/1523; H04L 67/306

(57) ABSTRACT

Embodiments for automating backup policies applied to users in an organization by defining backup policies based on hierarchical positions of users within the organization as modified by any communication and grouping behavior of the user within the organization. A social graph generator utilizes relevant relationships revealed by active participant communications to create a greater knowledge of data usage within the enterprise to generate social graphs that quantify a type of commonality between people. The integration of social graph information in calculating a score based on hierarchical data adds organizational awareness to the process by factoring in people's communication patterns within the organization and leverages any links that are revealed by such patterns.

### CROSS-REFERENCE TO RELATED APPLICATIONS

The present application is a Continuation-In-Part application and claims priority to U.S. patent application Ser. No. 17/193,342 filed on Mar. 5, 2021, entitled “Organizational Awareness For Automating Data Protection Policies,” and assigned to the assignee of the present application.

### TECHNICAL FIELD

This invention relates generally to data protection systems, and more specifically to incorporating organizational awareness with social graphing for automating data protection policies.

### BACKGROUND

Backup software is used by large organizations to store their data for recovery after system failures, routine maintenance, archiving, and so on. Backup sets are typically taken on a regular basis, such as hourly, daily, weekly, and so on, and can comprise vast amounts of information. Backup programs are often provided by vendors that provide backup infrastructure (software and/or hardware) to customers under service level agreements (SLA) that set out certain service level objectives (SLO) that dictate minimum standards for important operational criteria such as uptime and response time, etc. Within a large organization, dedicated IT personnel or departments are typically used to administer the backup operations and work with vendors to resolve issues and keep their infrastructure current.

Data within an organization is typically not considered to be monolithic as far as data protection policies are concerned. As enterprise systems grow and become more complex, the data for different assets within the organization, such as personnel, machines, data sources, and so on may be assigned different data protection policies so that storage costs and SLOs can be optimally tailored to the appropriate types of data.

In present systems, data assets are manually assigned to specific policies by system administrators in what is largely a manual process. Some advanced systems, such as VMware platforms, may allow assets to be automatically assigned to policies based on virtual center (vCenter) tags, but the mappings between policies and tags must still be manually configured by administrators. Other backup software products may custom protect certain types of data, such as e-mail systems (e.g., Microsoft Exchange) based on information from directory services like LDAP (Lightweight Directory Access Protocol) or Microsoft Active Directory for authentication and authorization. However, this software generally does not use the content of those systems to assign assets to protection policies and keep the assignments current. In a company with potentially tens of thousands of employees, employee devices, and the constant change involved with people being added, promoted, reassigned, or removed on an almost daily basis, administrators are forced to rely on either manual efforts or external, static automation workflows to update assignments. All of this adds significant administrative overhead, as well as gaps in data protection, and opportunities for data breaches.

What is needed, therefore is a data protection system that automatically incorporates organizational awareness to efficiently apply data protection policies or policy attributes to specific assets within an organization and thereby eliminate present manual or ad-hoc methods of tagging data to the policies.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. EMC, Data Domain and Data Domain Restorer are trademarks of DellEMC Corporation.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a diagram of a network implementing an organization classifier to assign assets to data protection policies, under some embodiments.

FIG. 2 is a flowchart that illustrates an overall method of assigning assets to data protection policies using automated organization awareness, under some embodiments.

FIG. 3 illustrates the interconnection between the organization classifier and backup software components in a data protection environment, under some embodiments.

FIG. 4 illustrates an example graph for an organization showing a hierarchy of certain personnel and devices, as used in some embodiments.

FIG. 5 is a flow diagram illustrating a process generating a score for people within a hierarchy for application of data protection policies, under some embodiments.

FIG. 6 illustrates the composition of the total score calculated by the organization classifier, under some embodiments.

FIG. 7A is a first table illustrating some an example of a set of scores for an organization, under an example embodiment.

FIG. 7B is a second table illustrating the impact of personnel changes to the example table of FIG. 7A.

FIG. 8 is a table that illustrates the mapping of total scores to available data protection policies, under an example embodiment.

FIG. 9 illustrates the interconnection between a social graph generator and an organization classifier, under some embodiments.

FIG. 10 illustrates an simple example social graph that can be computed from certain data relationships.

FIG. 11 illustrates social graph input to an organizational classifier for calculation of a total OC score for a user, under some embodiments.

FIG. 12 is a table that lists some example factors derived from communication systems for use by the social graph generator, under some embodiments.

FIG. 13 is a flowchart illustrating a method of updating a boost score using social graph data, under some embodiments.

FIG. 14 is a system block diagram of a computer system used to execute one or more software components of an organization awareness method for automating data protection policies, under some embodiments.

### DETAILED DESCRIPTION

A detailed description of one or more embodiments is provided below along with accompanying figures that illustrate the principles of the described embodiments. While aspects are described in conjunction with such embodiment(s), it should be understood that it is not limited to any one embodiment. On the contrary, the scope is limited only by the claims and the described embodiments encompass numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the certain methods and processes described herein. Applications may also be downloaded, in whole or in part, through the use of a software development kit or toolkit that enables the creation and implementation of the described embodiments. In this specification, these implementations, or any other form that embodiments may take, may be referred to as techniques. In general, the order of the steps of disclosed processes may be altered within the scope of the embodiments.

Some embodiments involve data processing in a distributed system, such as a cloud based network system or very large-scale wide area network (WAN), and metropolitan area network (MAN), however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

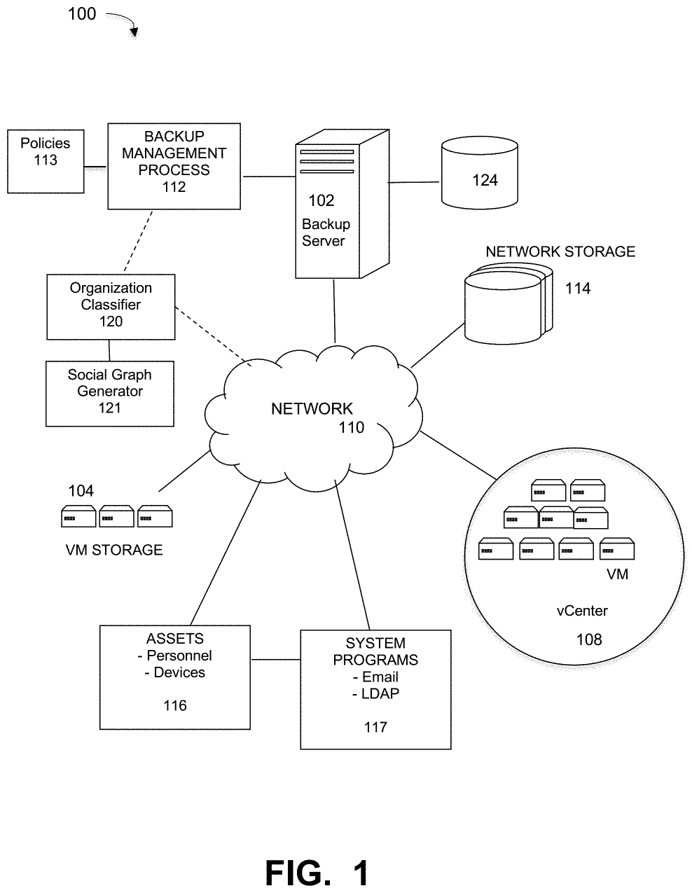

FIG. 1 illustrates a computer network system that implements one or more embodiments of implementing organization awareness for automating data protection policies, under some embodiments. In system 100, a storage server 102 executes a data storage or backup management process 112 that coordinates or manages the backup of data from one or more data sources 108 to storage devices, such as network storage 114, client storage, and/or virtual storage devices 104. With regard to virtual storage 104, any number of virtual machines (VMs) or groups of VMs may be provided to serve as backup targets. FIG. 1 illustrates a virtualized data center (vCenter) 108 that includes any number of VMs for target storage. The backup server implements certain backup policies 113 defined for the backup management process 112, which set relevant backup parameters such as backup schedule, storage targets, data restore procedures, and so on. In an embodiment, system 100 may comprise at least part of a Data Domain Restorer (DDR)-based deduplication storage system, and storage server 102 may be implemented as a DDR Deduplication Storage server provided by EMC Corporation. However, other similar backup and storage systems are also possible.

The network server computers are coupled directly or indirectly to the network storage 114, target VMs 104, data center 108, and the data sources 106 and other resources 116/117 through network 110, which is typically a public cloud network (but may also be a private cloud, LAN, WAN or other similar network). Network 110 provides connectivity to the various systems, components, and resources of system 100, and may be implemented using protocols such as Transmission Control Protocol (TCP) and/or Internet Protocol (IP), well known in the relevant arts. In a cloud computing environment, network 110 represents a network in which applications, servers and data are maintained and provided through a centralized cloud computing

Backup software vendors typically provide service under a service level agreement (SLA) that establishes the terms and costs to use the network and transmit/store data specifies minimum resource allocations (e.g., storage space) and performance requirements (e.g., network bandwidth) provided by the provider. The backup software may be any suitable backup program such as Dell EMC NetWorker, Avamar, and so on. In cloud networks, it may be provided by a cloud service provider server that may be maintained be a company such as Amazon, EMC, Apple, Cisco, Citrix, IBM, Google, Microsoft, Salesforce.com, and so on.

In most large-scale enterprises or entities that process large amounts of data, different types of data are routinely generated and must be backed up for data recovery purposes. This data comes from many different sources and is used for many different purposes. Some of the data may be routine, while others may be mission-critical, confidential, sensitive, and so on. As shown in the example of FIG. 1, the assets can include not only data sources, such as VMs 108, but other sources 116 that generate data or that require or benefit from different data backup and restore schedules. These can include the people of the organization, their devices, certain facilities, and so on. For example, if a certain class of personnel, such as executives create particularly sensitive or important data, policies that ensure secure and fast storage may be implemented for them, their devices, their teams, and so on, as opposed to having their data routinely archived with all the other normal data in the system. The assets 116 are often managed by access and control programs such as LDAP and/or they utilize certain critical programs within the company, such as e-mail, application software, and so on. System 100 includes an organization classifier component 120 that analyzes such programs to determine the appropriate backup policies 113 to apply to the assets 116.

As shown in FIG. 1, system 100 includes an organization classifier 120, which analyzes directory services and email systems to assign scores to users based on their positions within the company. The backup management process 112 can then use those scores to intelligently assign protection policies 113 to certain people. For instance, the OC can enable backup software to determine who in the organization is part of the executive core of the company and assign a policy with a 15-minute Recovery Point Objective (RPO), while systems belonging to less critical employees are assigned hourly or daily RPOs. In this manner, the data protection policy assignment is dynamic and scalable, while minimizing the work required from administrators or external workflow automation systems.

For the embodiment of FIG. 1, the organizational classifier 120 may be implemented as a component that runs within a data protection infrastructure, and can be run as an independent application or embedded into an instance of data protection software 112 or as part of a data protection appliance. Any of those implementations may also be on-premise implementations on client machines within a user's data center or running as a hosted service within the cloud.

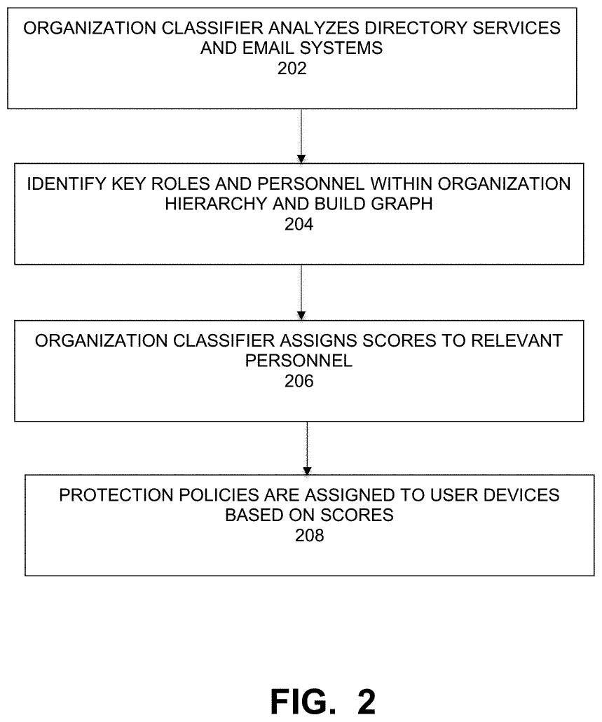

FIG. 2 is a flowchart that illustrates an overall method of assigning assets to data protection policies using automated organization awareness, under some embodiments. For this process, the organization classifier analyzes directory services and e-mail systems, along with any other relevant personnel interaction platforms, 202. The directory services provide information about the formal hierarchy of the organization, while the e-mail and other programs provide insight into informal or more practical relationships among the personnel. Through this analysis the key roles and personnel are identified within the organization hierarchy, 204. The organization classifier then builds its own graph mapping devices to people and people to each other in the hierarchy. The organization classifier calculates and assigns a score to each identified person, 206. These scores are then used by the data protection system to intelligently automate the assignment of users' devices to specific protection policies, 208.

The process of FIG. 2 provides a way to easily assign different policies to different people, or to the same people at different times depending on different data contexts. For example, data for top level personnel may always be protected at the highest level, but people involved in a particular project may have their data protected at this same level while working on the project, but revert to normal levels of data protection afterward. Likewise, some people identified by the e-mail or other programs may be flagged as generating highly important data, even though their position in the formal hierarchy alone may not warrant the application of special data protection policies. Furthermore, certain data protection policies may be defined for certain contexts, such as movement and storage of legal documents during litigation, where strict legal rules and court orders dictate data processing, or storage of medical records subject to HIPAA compliance, and so on.

FIG. 3 illustrates the interconnection between the organization classifier and backup software components in a data protection environment, under some embodiments. As shown in diagram 300 of FIG. 3, the organization classifier component 310 takes inputs from directory services 302 and Email systems 304 and internally generates a graph (or other representation) of the organization. The organization classifier then uses that graph to assign a score to each individual, where the score represents their importance level within the organization, and keeps those scores updated as the organization changes. The scores are then used by backup software 306 to assign protection policies 312 to those individuals' devices, such as their desktop computers, notebook computers, tablets, phones, and so on. These policies dictate backup schedules for storing the data in data protection storage 308, which may be tiered to provide different protection characteristics based on cost.

Inputs to the organization classifier 310 and backup software 306 is typically already integrated with directory services such as LDAP or Microsoft Active Directory, or similar. LDAP represents a type of application protocol for maintaining distributed directory information services over IP networks. Such directory services may provide an organized set of records in a hierarchical structure, such as a corporate e-mail directory. Although embodiments are described with respect to LDAP, any similar protocol can be used.

The organization classifier 310 can either share the configuration of one or more directory services 302 with the backup software 306, or the services 302 can be directly configured in the organization classifier itself. The backup software 306 may also be protecting the e-mail system 304 itself, and these this system may be using one of the directory services 302 to implement their Global Address Lists (GALs), or they may have their own internal corporate directories. The organization classifier 310 can either share the configuration of such systems with the backup software 306, or the services can be directly configured in the organization classifier itself. In a traditional organization, the GAL is considered sufficient to capture the full organization chart, but other embodiments of this component may integrate with other Enterprise Resource Planning (ERP) tools (e.g., Workday) to collect additional information about employees.

In an embodiment, the organization classifier 310 maintains an internal data structure represented as a graph. The graph is stored using a graph database, but other embodiments may use other data storage, such as a relational database, and the like. In a graph database, each node in the graph represents an object of a type including Domain, Group, User, Device, among others.

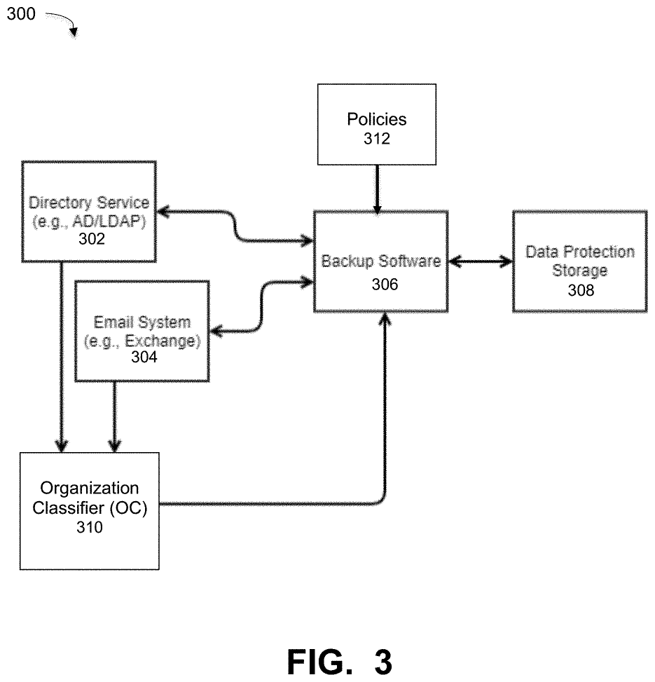

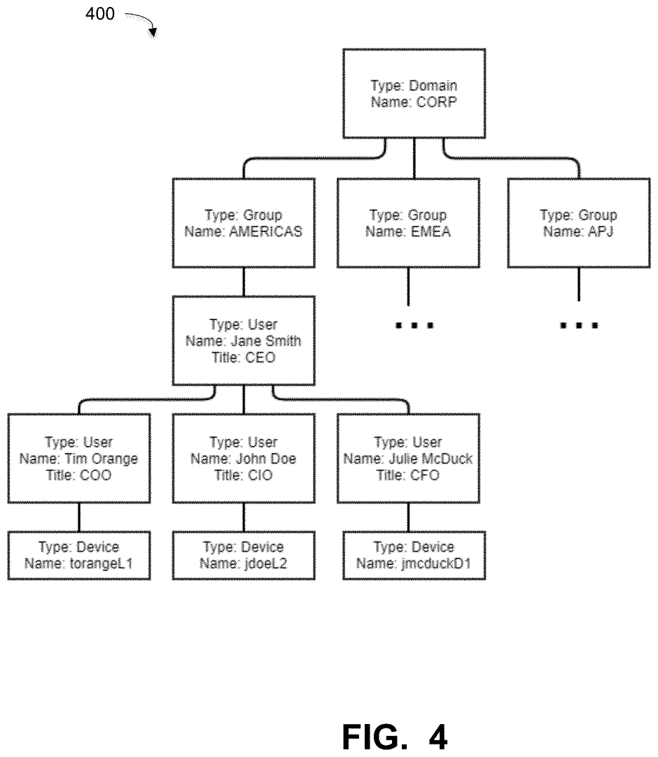

FIG. 4 illustrates an example graph as generated by the organization classifier for an organization showing a hierarchy of certain personnel and devices, as used in some embodiments. Graph 400 illustrates a graph based on objects of the types Domain, Group, User, and Device. The Domain object is a top level object and corresponds to the corporation or organization as a whole. This organization may be divided among different geographical regions, which each constitute a Group within the hierarchy. Each region then has a number of different people, each represented as a different User node. Each person may control one or more devices denoted by the Device nodes assigned to each User.

As shown in in FIG. 4, there is a many-to-one mapping of Devices to Users. In other words, a User may have one or more devices, but each device is assigned to only one primary User. The initial information regarding devices mapped to users may (typically) be provided by the LDAP system itself where company equipment is under custodial care of individual users. Alternatively, other databases may be used to provide this device to user assignment, such as IT department logs, and so on, if necessary.

With regard to the relationships among the people, there is a many-to-many mapping of Users to Groups. A User can be part of one or more Groups, and a Group may have one or more Users. Both Users and Groups have a many-to-one mapping to a Domain. Each User and each Group can be part of only one Domain. Diagram 400 is provided for purposes of illustration only, and many other hierarchies, node structures, and configurations may be used.

In general, the structure and content of the internally generated graph 400 should match, at least loosely, the original LDAP information. However, certain distinctions or other information may inform the organization classifier's internally generated graph depending on the analysis procedure. For example, when also integrated with an ERP system, the information from the ERP system may create differences between the internal graph and the LDAP source. An important element of the organization classifier graph, such as shown in FIG. 4, is the explicit mapping of devices to people within the hierarchy, as the policies regarding data backup will be imposed directly on these devices based on the identity of the device user.

The native types of each directory system are mapped to the types present within the organization classifier. For example, an Active Directory Organizational Unit (OU) maps to a Group. A set of key/value pairs are also associated with each node. These are used to cache data for the calculation of scores (as described below), such as number of emails received or sent.

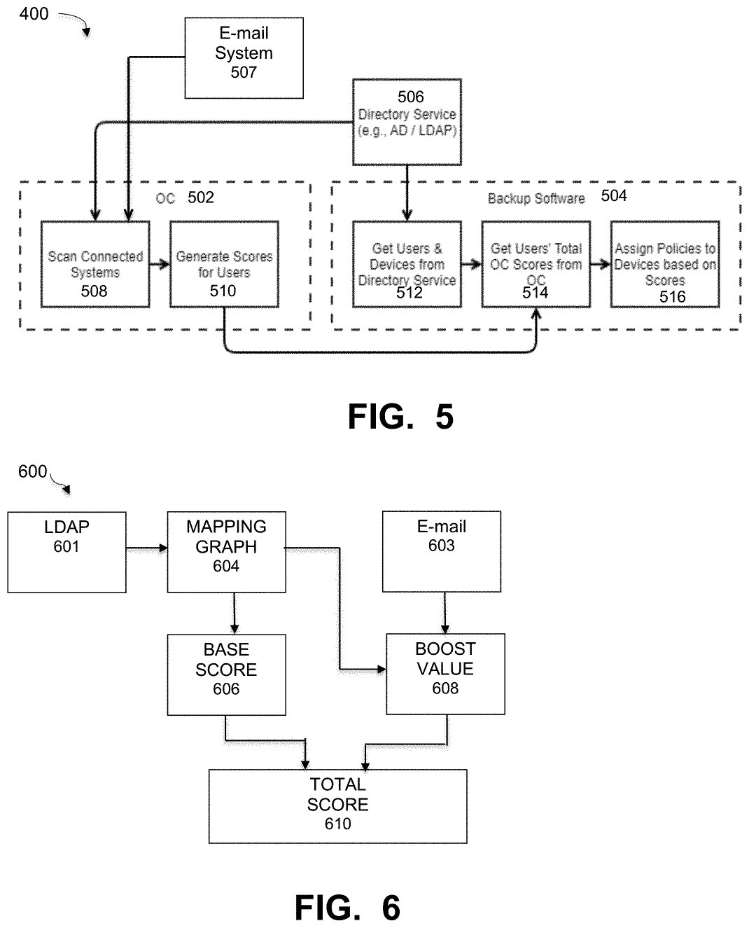

With reference back to FIG. 2, once the graph 400 is generated, the organization classifier assigns scores to each of the people. FIG. 5 is a flow diagram illustrating a process generating a score for people within a hierarchy for application of data protection policies, under some embodiments. As shown in diagram 500 of FIG. 5, the organization classifier 502 scans through connected systems in step 508. For each directory service system configured, the classifier 502 scans through and maps the objects within the directory service to its internal graph (e.g., 400). The scan is performed using the LDAP protocol 506.

Another connected system may be the company e-mail system 507. For each email system, if the email system is using one of the configured directory services for its user list, the classifier 502 scans through the mailboxes and extracts statistics, such as total number of emails, and adds those as key/value pairs to the node of the graph corresponding to the User who owns that mailbox. If an email system is not itself connected to a directory service, the classifier 502 will search its connected directory services for a matching email address to associate the Users. If no match is found, then the mailbox is ignored. Besides an e-mail system, other communication platforms may also be scanned, such as chatrooms, social network sites, electronic bulletin boards and so on. The e-mail system 507 data is used to cull information regarding user interactions that may help inform each individual's influence, impact, or importance in the company or a group. Such information may tend to indicate that the data used by that individual is more or less important than their simple LDAP hierarchy data may suggest. This data thus represents informal user interaction information that is used to supplement the formal data provided by the directory service 506. This informal information is not used to change a person's position in the generated graph, but rather to help modify the scoring of that person.

As shown in FIG. 5, after the classifier 502 scans the connected systems, it then generates the scores for the users, 510. In the organization classifier, each user in the graph is assigned a total score calculated as the sum of a base score minus a boost value. This is easily expressed in the following equation as:

Total OC Score=Base Score−Boost Value

The Base Score is assigned according to a user's position in the top-down corporate organizational chart, while the boost value is derived from the informal data (e.g., e-mails, communication patterns, and so on) along with certain organizational data. A lower total score indicates a higher importance within the company.

FIG. 6 illustrates the composition of the total score calculated by the organization classifier, under some embodiments. As shown in FIG. 6, the total score 610 is the combination of the base score 606 and the boost value 608. The base score is derived from the graph or map generated by the organization classifier 502 based on the directory service (LDAP) data 601. The boost value 608 is derived from the unstructured or informal communication information provided by the e-mail system and other similar programs used by people in the company. In addition, certain information from the graph 604 may also be used for the boost value, such as a user's membership or participation with certain other people or devices in the company. An example of the derivation of a total score, will be provided below.

With respect to the base score 606, this score is calculated on the basis of a user's location at in the graph, where the graph position corresponds to a user's ‘importance’ in the company, therefore the value of his or her data. An inverse scale is used so that a lower number denotes higher importance. A person at the top of the chart who does not report to anyone else, such as the President or CEO, has a base score of 1. Their direct reporting personnel (e.g., VPs) each have a base score of 2, those users' direct reporting personnel each have a base score of 4, and so on, with the score doubling for each level. An inverse scoring scale is used so that the graph can extend to an arbitrary number of levels without affecting the scores at the higher levels of the graph. Other embodiments may implement different scoring mechanisms, such as linearly increasing by a fixed number of points per level of hierarchy, normalizing the score to a specified range, or using a method where higher scores indicate higher importance, and so on.

The boost value is a numerical value subtracted from the base score based on one or more rules that capture the impact of a user's communications, associations, impact on other user, as well as any contextual situations impacting their data, such as special projects, temporary assignments, and so on. Table 1 below illustrates some example components of the boost value, in an example embodiment.

TABLE 1

Number of e-mail messages
E-mail Sender/Receiver Identity
Grouping with higher level users
Project assignments
External/Internal Associations

The example of Table 1 lists only some possible boost value factors, but generally represents the most salient factors of a user's communication and association within a company that may impact the value of their data. Any number of such factors may be used, and weighted relative to one another to derive a boost value for the individual.

Using Table 1 as an example, the number of work related e-mail messages received by a person is used to indicate their involvement in the company and therefore, to some degree at least, their importance in the company. Just as important, however, may be the people to whom this user is communicating. So, if the user receives a high number of e-mail messages, and if the number of email messages received per week from a user's manager, or other equally or higher-level managers from other parts of the organization, and exceeds a configurable threshold (e.g., 20 per week), that user's boost value may be set accordingly, where a lower boost value helps lower the overall score. This kind of data is provided almost exclusively by the e-mail programs, as well as other similar communication platforms (chatrooms, etc.).

As shown in FIG. 6, the boost value can also be impacted by the mapping graph 604. Thus, for example, if a group to which the user belongs within the directory system contains at least some configurable percentage (e.g., 60 percent) of other users at higher levels in the organization, their boost value can be adjusted accordingly. Likewise, if the number of groups to which the user belongs that contain users at the top levels of the organization exceeds a configurable threshold (e.g., 3 groups), then the boost value may be similarly adjusted. Internal or external associations with certain groups or people, as may be gleaned from the scanned communication channels may also impact a boost value. For example, a person who is part of an industry group or standards committee may use data that is important. The user's context outside of the formal company hierarchy may also be factored in, such as if the user is part of a special group or involved in an important current project, and so on.

These rules for determining the boost values are coded into the organization classifier 502, but other embodiments may allow for rules to be specified in an externalized resource file. The boost value can show that a person whose position in the organizational chart may be lower than another person's is effectively equally or more important than the other person based on their interactions with other important users or interaction with important data. Boost values can increase (negative boost value) or decrease (positive boost value) the user's overall score based on the factors considered.

With respect to determining an actual boost value for a user, in an embodiment, a threshold value is defined for each of the factors (such as those listed in Table 1). The organization classifier 502 derives a numeric value for each factor over the course of a scan 508 and compares the derived number to the defined threshold and assigns a zero, negative, or positive boost value for each measured factor. Alternatively, a system administrator can review the factor values received for a user and derive an appropriate boost factor for that user. For example, the system may be configured to allow only negative boost values to increase a user's importance, or it may also allow positive boost values to decrease a user's importance as well, and it may provide a manual override by an administrator.

This boost value is then combined with the base score 606 to derive the total score. The organization classifier 502 re-generates all scores at a fixed interval (e.g., daily), so the scores are dynamic in response to organizational changes such as promotions, reassignments, re-organizations, and so on.

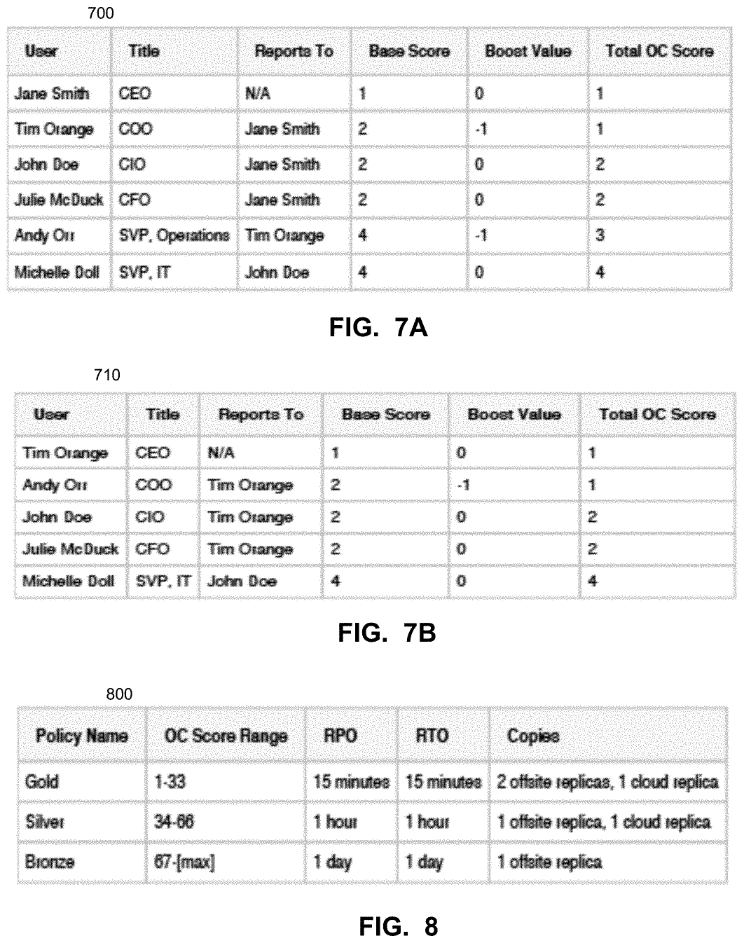

FIG. 7A is a table illustrating some an example of a set of scores for an organization, under an example embodiment. As shown in table 700, each user is listed with their title and reporting lines. This yields a base score derived from their position in the organization graph. Based on certain factors, such as the factors of Table 1 above, each user is then given a boost value, as calculated by the organization classifier. For the example of FIG. 7, it can be seen that in the cases of Tim Orange and Andy Orr, their boost values give them a lower Total OC Score (i.e., higher importance) than others at their level. On a later date, if Jane Smith decides to leave the company, and Tim Orange is promoted to CEO, the scores would be recalculated as shown in table 710 of FIG. 7B, where it can be seen that Tim Orange's base score changes from 2 to 1, and so on.

With reference back to FIG. 5, each user's total score is ultimately used by the backup software 504 to help determine that appropriate backup policies to apply to each user. The backup software 504 directly accesses the directory service database 506 to obtain user and device information for the users, 512. It obtains the total score 514 from the organization classifier 502 as calculated from the base score and boost values described above. Based on the score, the backup software 504 then assigns policies to the devices based on the respective user total score, 516. For this step, the backup software 504 can query the organization classifier 502 via an application program interface (API), such as REST, to retrieve the calculated total score for each user.

As shown in FIG. 5, the backup software 504 queries (in step 512) the directory services 506 for devices associated with the user (e.g., laptops or desktops) and e-mail systems for mailboxes associated with the user. The backup software then applies certain defined rules to map a range of total scores to policy attributes to be applied to those assets, step 516. The backup system may define a number of different backup policies with each policy providing different levels of backup performance or target storage type/location. Important parameters distinguishing these policies typically comprise the number of copies backed up, the target storage type or location, and the RPO (recovery point objective) and RTO (recovery time objective) of the backup data. Typically, higher performance storage or local more secure storage is priced at a higher cost than other types of storage, and thus system administrators must balance data importance against storage costs to cost optimize the data protection operations.

FIG. 8 is a table that illustrates the mapping of total scores to available data protection policies, under an example embodiment. The example table 800 of FIG. 8 lists three different policies in order of Gold, Silver, and Bronze, and which can be priced accordingly by a cloud or storage provider, and each providing different features, such as RPO, RTO and number of copies stored offsite or in the cloud. The possible range of total scores for this example can range from 1 to a maximum score over 67. For the example shown, users with a score of between 1 and 33 have their data stored under the Gold policy, those with scores between 34-66 have their data stored under the Silver policy, and those with scores of 67 above have their data stored under the Bronze policy. The example of FIG. 8 is provided for purposes of illustration only, and any number or characteristics of policies may be provided and used.

The appropriate total score range to assign to each policy may be defined by the system administrator, or it may be set automatically by the backup software based on certain objective data, such as number of total policies, number of distinct RPO/RTO values, number of copies specified, and so on. For the example table 800 of FIG. 8, if the backup software has only three policies, then the software may automatically distribute the score ranges across the policies with the lowest OC Score Range assigned to the policy with the lowest RPO, the next lowest OC Score Range assigned to the policy with the next lowest RPO, and so on. In some cases, the policy applied to a user or group of users based on their scores may conflict with one or more other rules defined by the backup system. In this case, the backup system rules will usually take precedence over any modification of policy assignments suggested by the organization classifier.

Advanced options allow creating backup policies or rules based on specific properties of users or groups of users. For example, systems in a group associated with Finance may have extended retention periods applied; or users directly or even remotely involved in legal proceedings may automatically have their data held under litigation hold rules, and so on.

### Social Graph Integration

As mentioned above, organizations typically have at least two hierarchies: a formal one represented by the reporting structure, and an informal one based on the social relationships between employees. Work may be distributed to employees based on the reporting structure, but collaboration often crosses those boundaries as employees seek out knowledge, information, experience, and wisdom from people across the organization. If someone in the company is a key enabler of executives, for example, then that person's assets should be protected to the same level as those executives' based on that person's collaboration as opposed to his or her own formal status or position.

Embodiments described above provide a system that assigns base scores to individuals within a company's reporting structure as represented in connected Directory Services (e.g., Microsoft Active Directory), augmented by a boost value based on signals extracted from connected Email Systems (e.g., Microsoft Exchange). Such messaging systems, however, are not always entirely sufficient by themselves to capture informal collaborative relationships, and as such, the scores generated may result data of important individuals not being assigned to the correct protection policies by backup software integrated with the organization classifier.

To overcome any drawbacks associated with such gaps in information, embodiments include an organization classifier that can leverage information about a social graph of a person or organization to augment the calculation of the boost value that is used to calculate a person's total OC score, where, as derived above:

Total OC Score=Base Score−Boost Value

For this embodiment, the overall data processing system 100 of FIG. 1, which has an organization classifier 120 to analyze directory services and email systems to assign scores to users based on their positions within the company is augmented to include a social graph generator 121 that is included in, or accessed by the organization classifier 120. In a typical social graph, each node represents a person, and links between nodes show interaction between pairs of people. A social graph may be of any size based on the number of nodes (people) in the organization, and each node may have any number of links depending on the total number of nodes.

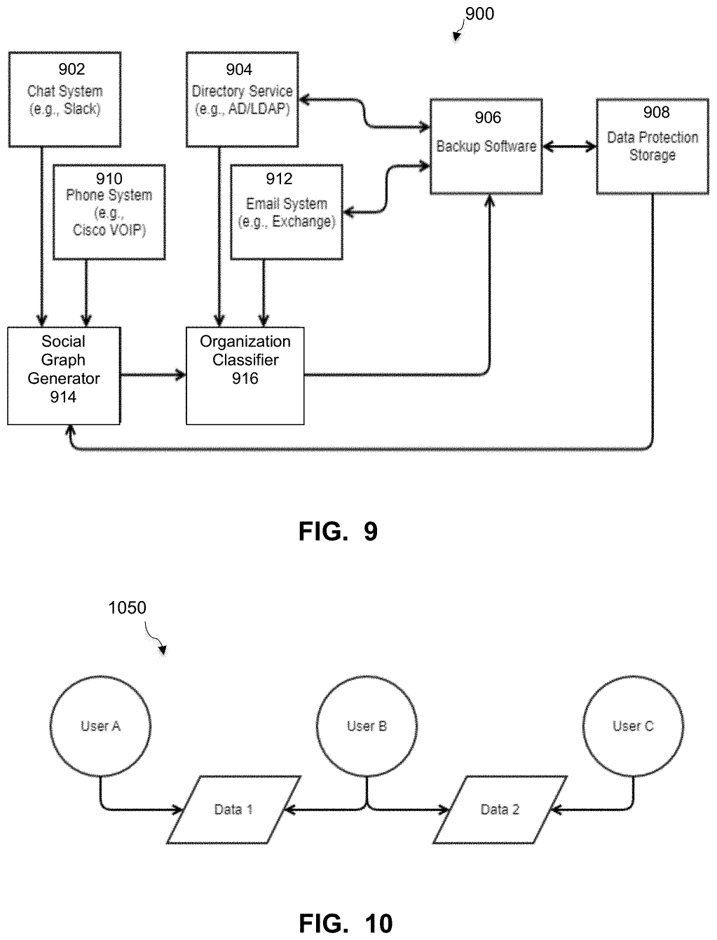

FIG. 9 illustrates the interconnection between a social graph generator and an organization classifier, under some embodiments. System 900 represents an extension of system 300 of FIG. 3 to include certain social graph data inputs to further inform the organization classifier functionality. As described previously, in system 900, the organization classifier component 916 takes inputs from directory services 904 and Email systems 912 and assigns scores to each individual representing their importance level within the organization. The scores are then used by backup software 906 to assign protection policies to those individuals' devices, such as their desktop computers, notebook computers, tablets, phones, and so on. These policies dictate backup schedules for storing the data in data protection storage 908, which may be tiered to provide different protection characteristics based on cost.

In an embodiment, system 900 includes a social graph generator that takes input from other communication systems (internal and external) used by the individuals in the organization, such as chat systems 902, phone systems (e.g., landline, cellular, Internet), and other similar communication platforms to generate a social graph illustrating relationships among people based on their communication interactions. This social graph information from social graph generator 914 is then input to the organization classifier 916 to provide further data to calculate the overall score (total OC score) for each individual.

In an embodiment, the social graph generator leverages relations revealed by active participant communications to generate a greater knowledge of data usage within the enterprise to generate social graphs that quantify a type of commonality between people to reveal complex and relevant relationships within the organization. The integration of social graph information in calculating a user's total OC score essentially adds a degree of organizational awareness to the overall process by factoring in people's communication patterns within the organization and utilizing any links that are revealed by such patterns.

A social graph can be built by exploiting known commonality between users. As it relates to file backup and storage data, a social graph can be built by using file data and/or file metadata attributes. Such a social graph can be valuable as people who have file data in common may have a relationship. They may work in the same company, department, team or project, or they may simply have a personal relationship that drives them to share certain data. In short, commonality of data between two individuals indicates a stronger strength of relationship. For example, sets of hashes representing the segments of data stored by each individual on their systems are compared to find the percentage in common. Two individuals who have 60% of hashes in common are determined to have a closer relationship than two individuals with only 15% of hashes in common. This process is repeated in an efficient manner across the organization to generate a graph of relationships between relevant individuals.

In the context of a data protection network, social graphs can be built using file data and/or file metadata attributes. Building a social graph this way can be done without requiring any action or knowledge on the part of the users. The file data used for constructing such a graph may consist of one or more of the following: (1) file name and other file metadata (size, creation time, access/ownership), (2) full file contents, and (3) sub file contents. While a filename by itself is of minimal value, the full file metadata can be a valid key to detect commonality. Common file contents between users can also be a valid key to establish a relationship between users when the size of the contents is non-trivial (e.g., larger than 1000 bytes). This can be more useful in some cases, as it allows sub-file contents to be evaluated. Furthermore, human readable files such as text files, spreadsheets, documents, etc. are most likely better indicators than binary data files (e.g., databases) due to fixed templates that may be in use in binary files.

An example social graph can be constructed using access information to a repository that contains file data for a number of users along with file access/ownership information. In a large-scale system, millions of data relationships can be easily computed from such a repository. FIG. 10 illustrates an simple example social graph that can be computed from certain data relationships. In the social graph 1050, user A and user B both own (or have access to) the same data item, Data 1, and user B and user C both own (or have access to) the same data item, Data 2. The social graph shows a clear link between user A and user B through one shared data item, and the link between user B and user C through a different shared data item, as well as the lack of any link between user A and user C based on this particular measure of interaction, i.e., sharing data items.

Building such social graphs requires a mechanism by which data items can be associated with the system users that have access to a data item. For example, in the case of a deduplicated backup system, a local “hash cache” is stored which is a list of all data item hashes that were sent to the deduplication server. In a client-side deduplication system where the client computer asks the deduplication server if it contains the data associated with a hash, the client can obtain a set of all the hashes that it has sent to the deduplication server. By analyzing these lists across multiple clients a social graph as described above can be computed. Similar methods can be used for server-side deduplication systems as well.

The social graph generator takes inputs that are not present in the organizational chart and output a graph based on user commonalities (i.e., shared data) and consequent connections. As discussed above, one basis for this is to examine hash values stored by data protection systems. Alternatively, such commonalities may be identified by simply looking at the number of common files stored on the system by name and size, for example. Call or text message logs can thus be used to provide data that is processed to find commonalities used by the social graph generator.

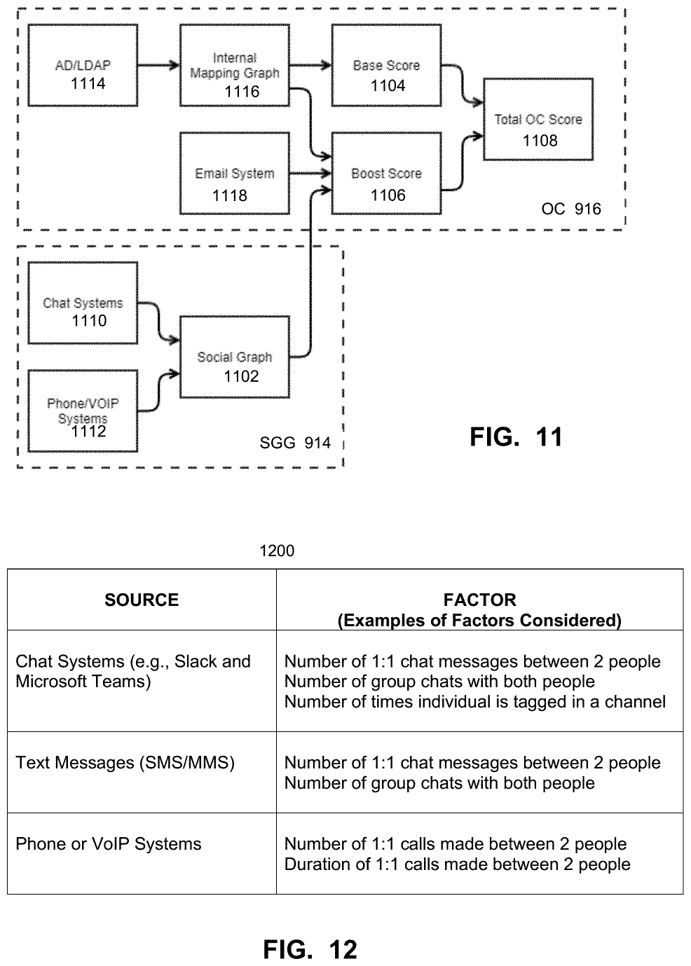

In an embodiment, the social graph is generated by the social graph generator 914 and processed by the organization classifier 916 to update the boost value that is used to calculate a user's total overall OC score. FIG. 11 illustrates social graph input to an organizational classifier for calculation of a total OC score for a user, under some embodiments. As shown in FIG. 11, the organization classifier (OC) 916 has components that calculate the total OC score 1108 based on a base score 1104 modified by a boost score or value 1106. The base score 1104 is generated by the AD/LDAP factors 1114 and internal mapping graph 1116 information as described earlier (e.g., with respect to FIG. 6), and within the OC 916, the boost score is determined by input from the E-mail system, also as described earlier. For the embodiment of FIG. 11, the social graph generator (SGG) 914 creates a social graph 1102 using inputs from chat 1110, phone 1112, and other similar communication networks or platforms. This social graph information is then quantized and input to the boost score calculator 1106 to add a further component that is used to calculate the total OC score 1108.

As shown in FIG. 11, the social graph generator 914 may use various different (non-Email) communication systems may to provide data to generate the social graph 1102. Examples include chat systems, phone (landline, cellular, Internet, etc.), and other similar communication systems. Usage of these communication systems by users may often reveal temporary or routine interaction among people that constitute relevant links that may not be discernible using only the hierarchical (e.g., LDAP) and E-mail information, as described above. Thus, besides the commonality of data and the formal relationships between people, informal communication among users can also be used to more accurately determine a person's realistic OC score within the organization.

Any relevant basis of interaction can be used to identify the links revealed by social graphs, and for the embodiment of FIG. 9, the relevant parameters involve communication using phones, chat lines, and similar interactivity methods. Data items, such as sender/receiver identities, call duration, call locations (for portable communication devices), call times, and so on for both phone calls and text messages can be used. For example, as with commonality between files and data, if the duration of phone calls between two users accounts for 30% of those users' total call durations, then those users are determined to have a closer relationship than two users whose calls to each other account for only 10% of their cumulative durations. Such values can be calculated for each pair of users across an organization to generate the graph of relationships between relevant individuals.

FIG. 12 is a table 1200 that lists some example factors derived from communication systems for use by the social graph generator, under some embodiments. Table 1200 lists the various sources of communication data, such as chat systems, text messaging systems, and phone systems. Various different factors can be identified and measured to discern relevant connections among people. For example, one-to-one calls or chats between people that are of a reasonable length may indicate a relevant link, as might be multi-party chats or calls that always involve the same two or core number of people. Thus, as shown in FIG. 12, example factors include number of 1:1 or group chats, texts, or calls. Table 1200 is provided for purpose of illustration only, and many other factors may be used for the listed sources, as well as other possible sources of such communication data.

As shown for table 1200, the data for each Factor from each item in the Source column is processed by the social graph generator to produce a value, such as number of calls between two users. In an embodiment, only the data not previously sent to the social graph generator is sent to the social graph generator on subsequent processing operations. The resulting values for each combination of Source and Factor parameters are stored as scores (S) associated with the link between the two nodes in the social graph. If one or more nodes do not already exist, they are added to the graph and linked appropriately prior to the scores being recorded.

After all such values are calculated upon completion of processing all data received from all Sources, a cumulative score (CS) for each link is calculated to represent a similarity value for that link. The cumulative score is calculated by traversing the graph, for example using a breadth-first algorithm, assigning a weight to each factor for a given source, along with a weight for each source. For instance, the weights for chat systems factors may be assigned as follows: number of 1:1 chat messages between 2 people (40%), number of group chats with both people (40%), number of times an individual is tagged in a channel (20%). In turn, the weights for the sources themselves may be assigned as follows: chat systems (30%), text messages (30%), phone or VoIP systems (40%). These weights are stored in a configuration file managed by the social graph generator, and have default values but may be re-configured by users.

Given that each score value may be in different units, such as number of calls versus duration of calls, the configuration and application of the weightings defines the resulting range of CS values. The highest cumulative score or maximum cumulative score (max(CS)) across the graph is recorded by the social graph generator as part of this process, so that it can be used to normalize the scores across the entirety of the graph in other functions implemented by the social graph generator, as described below.

The communications may be monitored over time to see if any other useful patterns emerge. For example, if any routine behavior or periodicity of the calls or messages is detected regardless of duration, this information may be useful to reveal certain linkages as well.

In an embodiment, the social graph is generated by the social graph generator 914 and processed by the organization classifier 916 to update, with phone/text communication factors, the boost score that was previously calculated for the directory service 1114 and Email system 1118 inputs.

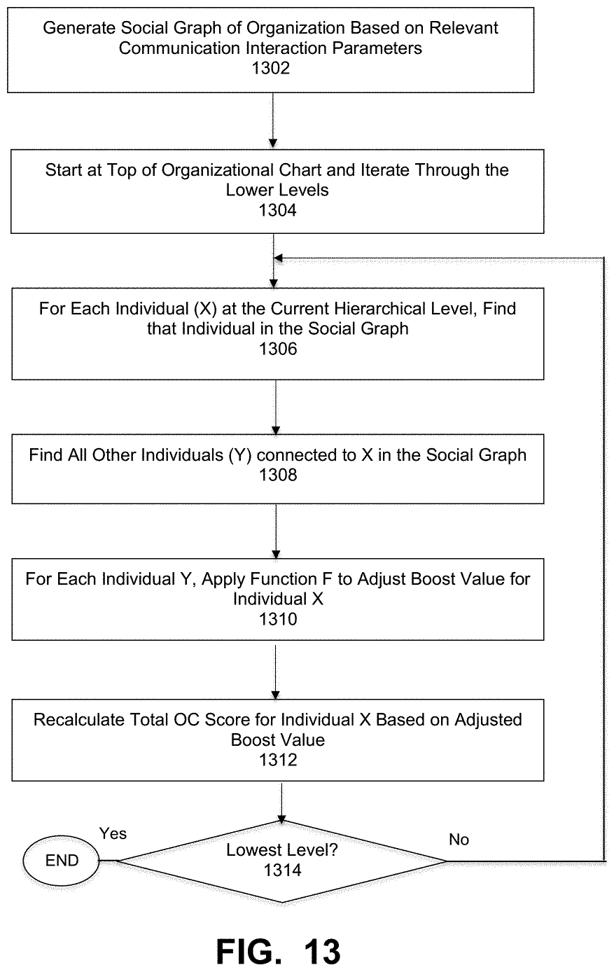

FIG. 13 is a flowchart illustrating a method of updating a boost score using social graph data, under some embodiments. As shown in FIG. 13, the process starts with the generation of a social graph 1102 by the social graph generator 914 based on the relevant communication interaction parameters, 1302. As part of this graph generation, the highest cumulative score, max(CS), for any link between nodes is noted. The process then starts at the top of the organization chart (e.g., FIG. 4), 1304, and for each individual X at the current level, the process finds that individual in the social graph, 1306. If an individual is not present at the current level, the next individual is processed until all individuals in each level are processed.

For each individual found at a particular level, the process then finds all other individuals Y connected to them on the social graph, 1308. For each individual Y, the process applies a function F to adjust the boost value for individual X, 1310. The function F adds a modifier (negative boost adder) based on a degree of similarity between individuals X and Y. For example, the function F may be defined as: divide the cumulative score for the link between X and Y by max(CS) to find the similarity %; then, for every N % of similarity, add −1 to the boost value. As boost levels are negative, given the formula: Total OC score=[base score]−[boost value], lower boost values indicate increased importance in the Total OC score.

The function F may be defined differently for each social graph or application, and the percentage similarity N is user configurable and should be tuned per organization to generate an acceptable range of boost scores for that organization. For instance, for one organization, setting N to 40 may create boost values between 0 and −3, which it deems acceptable. On the other hand, a different organization may want the contribution of the social graph to be smaller, and therefore set N to a different value that cause the range of boost values produced to be limited to between 0 and −1 only. Yet another organization may need to supply a more complex formula to achieve its desired results. These formulas are supplied to the social graph generator as script files using a pre-defined format and variable naming convention.

Once the boost value for an individual is appropriately adjusted, the total OC score for that individual is then recalculated, 1312. The process then iterates through the lower levels by determining whether or not the lowest level has been currently processed, 1314. If so, the process ends, otherwise it goes to the next lower level to process individuals within that level, and so on.

In summary, the links between the nodes of the social graph, where each node represents a person in the organization, thus gets a score S. Those scores are generated from inputs with different units (e.g., number of calls vs. call duration, etc.), so configurable weightings are applied to produce a cumulative score (CS) for each link. The highest cumulative for any link across the graph is recorded [max(CS)], so that each link's cumulative score can be further divided by max(CS) in function F to produce a normalized similarity % between 0 and 100. That percentage can then be used to determine the boost value applied (e.g., −1 for every 40%).

Although embodiments of the social graph aspect of the overall system were described in relation to input from chat and phone communication systems, embodiments are not so limited, and any other communication platform that yields one-to-one, one-to-many, many-to-many interactions involving persons within the organization are also possible. These can include social network platforms (e.g., Linked-In, Facebook, Twitter, WhatsApp, etc.), file sharing platforms (e.g., Instagram, etc.), and the like.

The embodiments described herein optimize data backup operations by using interaction information from directory service systems (e.g., LDAP, Active Directory), as well as communication programs (e.g., E-mail) and social graph information derived from other user communications (e.g., phone, message) automatically apply data protection policies to users based on their individual status and data usage patterns. A social graph generator leverages relations revealed by participant phone and chat communications to create a greater knowledge of personal interactions within the enterprise to modify organization classifier scores that determine the policy applications.

### System Implementation

Embodiments of the processes and techniques described above can be implemented on any appropriate backup system operating environment or file system, or network server system. Such embodiments may include other or alternative data structures or definitions as needed or appropriate.

The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

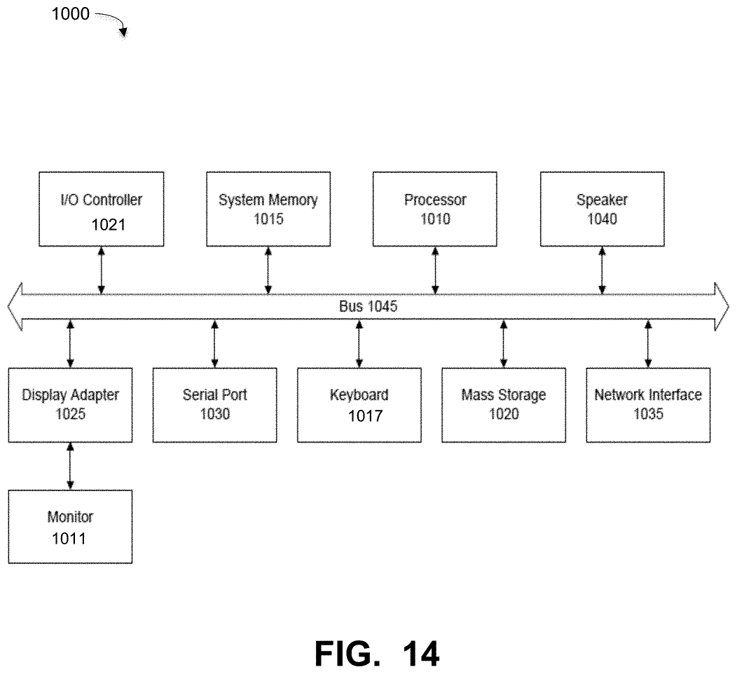

The network of FIG. 1 may comprise any number of individual client-server networks coupled over the Internet or similar large-scale network or portion thereof. Each node in the network(s) comprises a computing device capable of executing software code to perform the processing steps described herein. FIG. 14 shows a system block diagram of a computer system used to execute one or more software components of the present system described herein. The computer system 1000 includes a monitor 1011, keyboard 1017, and mass storage devices 1020. Computer system 1000 further includes subsystems such as central processor 1010, system memory 1015, I/O controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is just one example of a computer system suitable for use with the present system. Other configurations of subsystems suitable for use with the described embodiments will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system 1005 may be one of the Microsoft Windows®. family of systems (e.g., Windows Server), Linux, Mac OS X, IRIX32, or IRIX64. Other operating systems may be used. Microsoft Windows is a trademark of Microsoft Corporation.

The computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11e, 802.11g, 802.11i, 802.11n, 802.11ac, and 802.11ad, among other examples), near field communication (NFC), radio-frequency identification (RFID), mobile or cellular wireless. For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

For the sake of clarity, the processes and methods herein have been illustrated with a specific flow, but it should be understood that other sequences may be possible and that some may be performed in parallel, without departing from the spirit of the described embodiments. Additionally, steps may be subdivided or combined. As disclosed herein, software written in accordance certain embodiments may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer-implemented method of automating backup policy application to users in a data protection system of an organization, comprising:
obtaining organizational hierarchy information about the users from a directory service used by the organization;
deriving a base score for each user based on a position of the user within the organization;
obtaining communication and grouping information about the user from electronic mail programs one or more communication programs used by the users;
deriving a score modifier value from the communication and grouping information, including interaction among users through one or more communication systems;
calculating a total score for each user by combining its respective base score and score modifier value;
defining a total score range to each policy of a plurality of backup policies provided by the data protection system; and
applying a respective policy to data process by the user based a match of their respective total score relative to the total score range of the respective policy.

2. The method of claim 1 wherein the directory service comprises one of a Lightweight Directory Access Protocol (LDAP) database, or a Microsoft Active Directory database, and wherein the one or more communication programs comprise phone, message, and text based communication platforms used by the users to communicate with one another.

3. The method of claim 2 further comprising determining a source of communication and an associated factor for one or more communication types of each communication program, the communication types including a number of other users communicating in a group or alone with a target user, a communication medium of the communication medium, and a length or periodicity of the communication.

4. The method of claim 3 further comprising:
assigning an initial score to each combination of source and associated factor for the target user;
combining the initial scores for each combination to derive a cumulative score for each link between the target user and each of the other users, the cumulative score representing a similarity value between the target user and each linked user; and
storing the highest cumulative score for any link.

5. The method of claim 4 wherein a greater score is assigned to one-to-one communication between the target user versus grouped users, and for a voice-based communication medium versus a text-based communication medium.

6. The method of claim 4 further comprising deriving a cumulative score for each user in the organization as the target user in a hierarchical manner starting from a topmost level of an organizational chart of the organization and iteratively processing each user in each level of the chart.

7. The method of claim 6 further comprising generating a social graph for each user as the target user by finding all other users connected to the target user through the one or more communication programs.

8. The method of claim 4 wherein the base score is scored on an inverse scale and is derived directly from the user position in the hierarchy with top level users having no upward reporting lines assigned a lower score and middle and lower level users with multiple upward reporting lines having positive integer scores proportional to a number of reporting lines, and wherein the score modifier value modifies the base score based on the similarity value between the target user and each linked user.

9. The method of claim 8 wherein the similarity value is calculated by dividing the cumulative score for each link by the maximum cumulative score to obtain a similarity percentage for the link between the target user and another user, and assigning an additive factor for that similarity percentage based on percentage amount, and further comprising adding the additive factor to the base score to derive the total score, that in turn determines the applied respective policy, wherein the respective policy is one of a plurality of backup policies, and specifies a target storage location, a recovery time objective, and a recovery point objective for data backed up under the backup policy.

10. (canceled)

10. A computer-implemented method of automating backup policy application to users in a data protection system of an organization, comprising:
defining a plurality of backup policies to apply to data processed by users in the organization, wherein each backup policy dictates a different performance characteristic based on storage cost and target storage type and location;
identifying a hierarchical position of a user within the organization;
determining communication and grouping behavior of the user within the organization;
using the communication behavior to generate a social graph of the user relative to other users in the organization based on communication parameters;
calculating a total score for the user based on the hierarchical position, grouping behavior, and the communication parameters; and
automatically assigning a policy of the plurality of backup policies to a data processing device operated by the user based on the total score for the user.

11. The method of claim 10 wherein the hierarchical position of the user is obtained by a directory service used by the organization, and the communication and grouping behavior is derived from one or more communication programs used by the user, and includes at least one e-mail program.

12. The method of claim 11 wherein the total score is derived by combining a base score with a score modifier value, wherein the base score is derived from the hierarchical position of the user in the organization.

13. The method of claim 12 wherein the base score is scored on an inverse scale and is derived directly from the user position in the hierarchy with top level users having no upward reporting lines assigned a lower score and middle and lower level users with multiple upward reporting lines having positive integer scores proportional to a number of reporting lines.

14. The method of claim 13 wherein the score modifier value is derived by using the communication information to derive a social graph including an individual being scored, wherein the social graph reveals links to other individuals that raise a level of importance of the individual within the organization, wherein the communication information comprises at least some of: identity of the other individuals, duration of communication between the individual and the other individuals, grouping of the other individuals, source location of the communication, and type of communication platform.

15. The method of claim 13 wherein the factors comprise at least one of: a number of e-mail messages transacted in a period of time, a relative hierarchical level to the user of senders and receivers of the e-mail messages, association in one or more groups with users of a higher hierarchical level; and association with people or groups inside or outside of the organization.

16. The method of claim 15 wherein the score modifier value for each factor is derived by: defining a threshold value for each factor;
obtaining an objective value for the user for the factor from the obtained communication and grouping information for the user; and
comparing the obtained value with the defined threshold value for the factor.

17. A system for automating backup policy application to users in a data protection system of an organization, comprising:
an organization classifier component obtaining organizational hierarchy information about the users from a directory service used by the organization, deriving a base score for each user based on a position of the user within the organization, obtaining communication and grouping information about the user from one or more communication programs used by the users, deriving a score modifier value from the communication and grouping information, and calculating a total score for each user by combining its respective base score and score modifier value;
a social graph generator using the communication behavior to generate a social graph of the user relative to other users in the organization based on communication parameters; and
a backup server computer defining a plurality of backup policies to apply to data processed by users in the organization, wherein each backup policy dictates a different performance characteristic based on storage cost and target storage type and location, defining a total score range to each policy of a plurality of backup policies provided by the data protection system, and applying a respective policy to data process by the user based a match of their respective total score relative to the total score range of the respective policy.

18. The system of claim 17 wherein the users each control and use at least one data processing device for the organization, and wherein the respective policy is applied to the at least one data processing device of a user, and wherein the method of claim 1 wherein the directory service comprises one of a Lightweight Directory Access Protocol (LDAP) database, or a Microsoft Active Directory database, and the one or more communication programs comprise at least one of an e-mail program, a chat program, a social network platform, and an electronic bulletin board program.

19. The system of claim 17 wherein the base score is scored on an inverse scale and is derived directly from the user position in the hierarchy with top level users having no upward reporting lines assigned a lower score and middle and lower level users with multiple upward reporting lines having positive integer scores proportional to a number of reporting lines, and wherein the score modifier value is derived by taking into account at least one of a plurality of factors defining communication and grouping activities of a user.

20. The system of claim 19 wherein the factors comprise at least one of: a number of e-mail messages transacted in a period of time, a relative hierarchical level to the user of senders and receivers of the e-mail messages, association in one or more groups with users of a higher hierarchical level; and association with people or groups inside or outside of the organization, and wherein the score modifier value for each factor is derived by using the communication information to derive a social graph including an individual being scored, wherein the social graph reveals links to other individuals that raise a level of importance of the individual within the organization, wherein the communication information comprises at least some of: identity of the other individuals, duration of communication between the individual and the other individuals, grouping of the other individuals, source location of the communication, and type of communication platform.
